(19) United States
(12) Patent Application Publication
(10) Pub. No.: US 2013/0101163 A1
(43) Pub. Date: Apr. 25, 2013

(54) METHOD AND/OR APPARATUS FOR LOCATION CONTEXT IDENTIFIER DISAMBIGUATION

(71) Applicants: Rajarshi GUPTA, Sunnyvale, CA (US); Hui CHAO, San Jose, CA (US); Saumitra Mohan DAS, San Jose, CA (US)

(72) Inventors: Rajarshi GUPTA, Sunnyvale, CA (US); Hui CHAO, San Jose, CA (US); Saumitra Mohan DAS, San Jose, CA (US)

(21) Appl. No.: 13/629,125

(22) Filed: Sep. 27, 2012

Related U.S. Application Data
(60) Provisional application No. 61/542,005, filed on Sep. 30, 2011.

(51) Int. Cl. G06K 9/00

(52) U.S. Cl. CPC G06K 9/00671
USPC 382/103

(57) ABSTRACT

The subject matter disclosed herein relates to a method, apparatus, and/or system for obtaining one or more images captured at a mobile device and determining a location context identifier (LCI) identifying an area including a location of the mobile device based, at least in part, on the one or more captured images. The LCI may be selected from among a plurality of LCIs.

### CROSS-REFERENCES TO RELATED APPLICATIONS

This application claims priority to provisional patent application Ser. No. 61/542,005, entitled “Method and/or Apparatus for Location Context Identifier Disambiguation,” which was filed on Sep. 30, 2011, the disclosure of which is incorporated by reference in its entirety as if fully set forth herein.

### BACKGROUND

1. Field:

The subject matter disclosed herein relates to a method, apparatus, and/or system for disambiguation between or among Location Context Identifiers covering mapped areas or locations.

2. Information:

Some mobile devices, such as mobile phones, notebook, computers, etc., have an ability to estimate location and/or position with a relatively high degree of precision. For example, some mobile devices may estimate location and/or position using a technology such as, for example, satellite positioning systems (SPS) (e.g., GPS, GLONASS, or Galileo) or advanced forward trilateration (AFLT), just to name a few among many possible examples. An application for a mobile device may utilize relatively high precision location information to provide a user with various services such as, for example, vehicle or pedestrian navigation, or location-based searching, to name a couple among many possible examples. Relatively high precision location information (e.g., obtained from GPS and/or the like) may be processed according to a global coordinate system (e.g., latitude and longitude or earth-centered xyz coordinates).

Although use of location information referenced to a global coordinate system may be useful in providing some services (e.g., outdoor vehicle navigation), such location information referenced to a global coordinate system may be impractical for other types of services such as indoor location and/or pedestrian navigation.

### BRIEF DESCRIPTION OF THE FIGURES

FIG. 1 is a diagram of messaging within a system for disambiguating between LCIs based at least in part on features extracted from captured images according to an implementation.

FIG. 2 is a schematic diagram of a mobile device or portable electronic device according to one implementation.

FIG. 3 illustrates an image of a multi-level view of an indoor area according to an implementation.

FIG. 4 is a flowchart of a process for determining a location context identifier (LCI) for an area according to an implementation.

FIG. 5 is a flowchart of a process for disambiguating between or among a plurality of LCIs according to an implementation.

FIG. 6 is a schematic diagram illustrating an example system that may include one or more devices configurable to implement techniques or processes for disambiguating between or among LCIs according to an implementation.

FIG. 7 illustrates an image of a portion of an interior of a hotel building according to an implementation.

FIGS. 8A and 8B are images of a staircase being descended and ascended, respectively, according to an implementation.

### DETAILED DESCRIPTION

One or more implementations as discussed herein may provide a system, method, or apparatus for estimating a location or position within or in relation to a structure, such as a shopping mall, office building, sports stadium, or any other type of building, for example. Information obtained or otherwise determined from one or more sensors within a camera (or other mobile device capable of acquiring images) may be utilized to determine a location within a structure. In one implementation, for example, a mobile device may contain a mapping application capable of displaying a map or capable of determining navigation instructions to direct a user within a structure. For example, a structure may contain one or more access points enabling a mobile device to communicate with a network.

In one implementation, a user's mobile device may determine a location of a structure in which it is located. If, for example, a mobile device is utilized within an outdoor environment where Satellite Position System (SPS) signals are available, the mobile device may estimate its location with a certain degree of precision and may access or display a particular map or a portion of map covering or associated with the estimated location. However, in an indoor environment, SPS signaling may not be available in some implementations and therefore a mobile device may not have an ability to estimate its location within a particular degree of precision by acquiring SPS signals alone. In situations where a location such as a latitude and longitude or being positioned within a particular building can be estimated, additional information may be beneficial such as, for example, an indication of which floor of the building the mobile device is likely located.

In one example implementation, a mobile device may estimate its location as being within a multi-level outdoor location, such as a sports stadium. However, even if SPS signals are available, SPS signals alone may not be sufficient to determine on which level of a stadium a person is located if, for example, multiple levels of the stadium are located at least partially above each other in an area near where the person is located. For example, SPS signals may be utilized to determine two-dimensional location coordinates, but not also a floor level in some implementations. There may also be some outdoor locations for which SPS signals are not available, such as within some valleys, canyons, or urban environments, for example.

If a mobile device is utilized within a particular structure, the mobile device may have estimated or acquired an estimate of its location prior to a user entering the structure with the mobile device. A previous known location estimate for a mobile device may, for example, be utilized to identify a structure or area in which the mobile device is likely to be located. In an implementation, there may be different maps indicating locations of access points associated with a structure or area. For example, in the case of an office building or shopping mall, there may be different maps covering each floor or level of the office building or mall. Moreover, there may also be certain structures, such as an airport which may comprise a relatively large single-story structure or which may comprise multiple stories, where one or more of the stories are relatively large. In one implementation, a map covering an area within which a mobile device is located may be transmitted or otherwise retrieved by a mobile device. For example, a mobile device may contact a network or Internet Protocol (IP) address for a mapping server and may acquire or request a particular map be transmitted to the mobile device. A mapping server may store multiple maps (varying in format, detail, etc.) for a particular structure, including features such as locations, various points of interest, access points (e.g., for positioning), and/or navigation assistance data. Such navigation assistance data may include, for example, associated ranging models, physical routing constraints, heatmap meta data (e.g., expected signal strengths and/or signal round trip times) covering particular locations over the area covered by the digital map. Such navigation assistance data may also include a probability heatmap for use in particle filtering techniques, for example.

In the case of a relatively large structure, transmission of all maps and associated available navigation assistance data available associated with an area to a mobile device may result in degradation of performance of the mobile device. For example, a significant amount of processing capability or bandwidth may be used to process received mapping information. Accordingly, instead of receiving all available maps or navigation assistance data mapping information, in one implementation, a mobile device may instead receive a map covering a current location of a mobile device within a structure. If a determination is made that a mobile device is located on the second floor of an office building or shopping mall, for example, navigation assistance data associated with the second floor of the office building or shopping mall may be transmitted to the mobile device. Similarly, if utilized within an airport, if a particular airport terminal in which the mobile device is located is determined, navigation assistance data associated with the particular airport terminal may be transmitted to the mobile device. Accordingly, by identifying or otherwise determining a particular location of a mobile device within a structure, relevant maps or navigation assistance data associated with the particular area may be identified and transmitted to the mobile device.

In one implementation, there may be different ways in which a location of a mobile device within a structure may be characterized or otherwise identified. For example, if a mobile device contains a camera, images acquired by the camera may be processed to characterize, describe, or identify a location of the mobile device within a structure. For example, a location context identifier (LCI) covering an area within which a mobile device is located may be identified or characterized based, at least in part, on camera images captured by the mobile device while within the area. A “Location context identifier” or “LCI,” as used herein may refer to information capable of identifying an area or location. Different LCIs may identify or characterize an area, such as, for example, an area for which navigation assistance data may be available. Various features may be extracted from a captured image and may be utilized to determine an LCI covering an area, such as displayed room numbers within an office building or hotel, displayed gate numbers within an airport, signage indicating a name of a store within a shopping mall, a printed or otherwise displayed business name, a number of visible items vertically or horizontally displaced relative to each other, such as floors above or below a current floor on which a mobile device is located within an open air atrium or other location in which multiple floors are visible, or information contained in a stairwell, to name just a few examples.

If features of one or more captured images are determined, extracted, recognized, or otherwise obtained, for example, the features may collectively be used to identify, describe, or characterize a location or area in which the mobile device is likely located and identify an LCI covering the area or location. For example, image features extracted from one or more images captured by a camera of a mobile device may be utilized to disambiguate or distinguish between or among multiple LCIs, such as those associated with various areas, such as floors, of a structure. In some embodiments, image features may be used to disambiguate between a plurality of potential or viable LCIs. For example, in some embodiments, a mobile device or server may determine which LCI (and/or map, assistance data, etc. associated with that LCI) to download or transmit to the mobile device, respectively, based on one or more wireless signals that the mobile device is receiving. If the mobile device is receiving a wireless signal from an access point (AP) uniquely associated with an LCI, for example, that LCI (and/or map, assistance data, etc. associated with that LCI) may be transmitted to or otherwise provided to the mobile device. In certain situations, however, a mobile device may be receiving wireless signals from a plurality of APs associated with a plurality of LCIs, such as, for example, if a separate LCI is associated with each floor of a structure and the mobile device is positioned within an atrium where wireless signals from APs on several different floors are received. In these situations, for example, the LCIs associated with a plurality of floors may be potential or viable LCIs, and image features may be used to disambiguate between such potential or viable LCIs.

In one implementation, a location server may store maps for multiple different areas of a structure, such as floors. A mobile device may capture images via a camera device and determine or identify one or more LCIs associated with features extracted from the images. The mobile device may, for example, transmit extracted image features to a location server and the location server may identify, describe, or characterize an LCI corresponding to an area based at least in part on the extracted image features. In one implementation, for example, a plurality of LCIs may be associated with various areas such as areas within a structure. Image features may be extracted from captured images to disambiguate between multiple LCIs so that, for example, an LCI associated with the extracted image features may be determined or identified. Navigation assistance data and/or a map, for example, associated with a determined or identified LCI may be transmitted to the mobile device and used in a mapping or navigation application.

In some implementations, information identifying, describing, or characterizing extracted image features may be transmitted to a location server which may perform an LCI disambiguation process to determine or identify an LCI. Alternatively, in some implementations a mobile device may itself determine or identify an LCI based at least in part on extracted image features. For example, an LCI most likely to correspond to extracted image features may be determined or otherwise identified, for example, by comparing extracted image features with known information identifying, describing, or characterizing an area. For example, if office number “200” is extracted from a captured image as an image feature, this information may be utilized to determine that a mobile device was located in an area near office number “200” within a structure such as an office building. In an implementation, there may be multiple LCIs for which corresponding navigation assistance data may be available. In an implementation, features extracted from one or more captured images, for example, may be utilized to disambiguate between a plurality of LCIs to determine or otherwise identify an LCI associated with the extracted features. In an implementation where an office number is extracted from a captured image, for example, an LCI identifying, describing, or characterizing an area may be disambiguated based at least in part on the extracted office number.

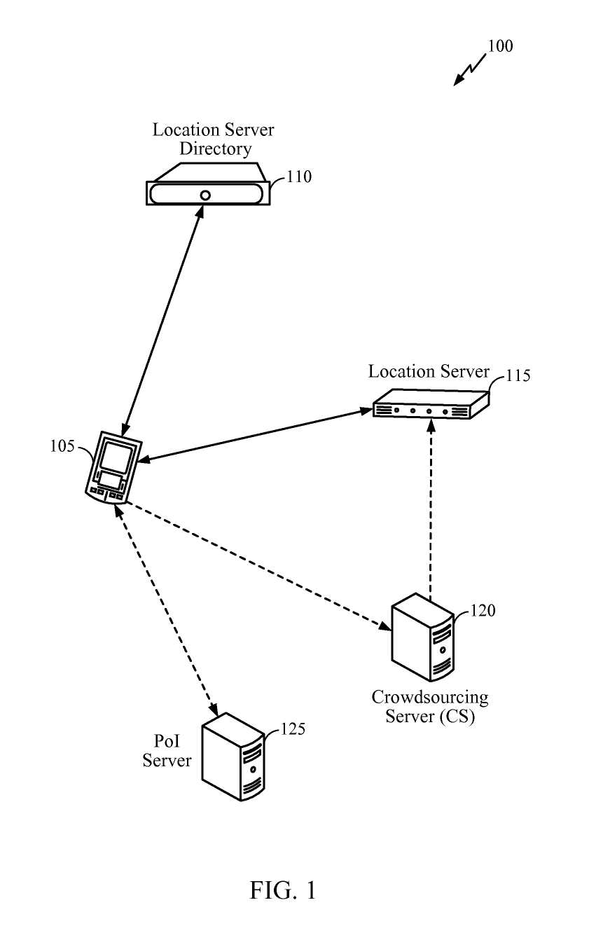

FIG. 1 is a diagram of messaging within a system 100 for disambiguating between LCIs based at least in part on features extracted from captured images according to an implementation. As shown, system 100 may include mobile device 105, location server directory 110, location server 115, crowdsourcing server (CS) 120, and a Point of Interest (PoI) server 125, for example. Mobile device 105 may include a camera to capture images, such as digital images, or may otherwise receive images from a camera in communication with mobile device 105. Mobile device 105 may receive information indicative of a location of the mobile device 105, such as, for example, information and/or signals received from local transmitters such as, for example, MAC identifiers (MAC IDs) from signals transmitted from one or more WiFi access points and/or received signal strength indications (RSSIs) related to same. Alternatively, the mobile device 105 may receive signals transmitted from a satellite positioning system such as GPS and/or information from an application programming interface capable of providing location information, for example.

In some implementations, satellite positioning system signals may not be available in certain areas, such as within certain structures. However, a mobile device may estimate its position based on communications with access points or other location transmitters, as discussed above. Information about access points or other local transmitters may be included within a heat map or may otherwise be identified, described, or characterized via navigation assistance data. If a rough location of a mobile device within a structure is determined or estimated, information about access points or other local transmitters may be transmitted to mobile device 105 and may be utilized by mobile device 105 to estimate its location.

In an example implementation, a rough location of mobile device 105 may be determined based as least in part on extracted features from one or more captured images. Mobile device 105 may extract one or more features from one or more captured images. For example, mobile device 105 may forward extracted features from captured images to location server 115, and location server 115 may utilize the extracted features to determine an LCI to identify, describe, or characterize an area associated with the extracted image features. For example, image features extracted from one or more images captured in front of a particular store in a shopping mall may be utilized to identify, describe, or characterize a location of mobile device 105 within the shopping mall at a time at which images were captured. An LCI identifying, describing, or characterizing the location may be disambiguated or determined from a plurality of LCIs based at least in part on image features. After an LCI identifying, describing, or characterizing the location has been determined, information about access points or other local transmitters may be transmitted to mobile device 105 based at least partially on the LCI, for example, or a map or other navigation data may be transmitted to mobile device 105, as another example.

Based, at least in part, on extracted image features received from mobile device 105, location server directory 110 may determine a rough location of the mobile device 105. In one particular example, location server directory 110 may associate a rough location estimate with an LCI covering an area including the rough location. An LCI may uniquely identify a locally defined area such as, for example, a particular floor of a building or other indoor area which is not mapped according to a global coordinate system, for example. Location server directory 110 may transmit, to mobile device 105, a universal resource indicator (URI) address to a particular location server 115 from which a local digital map and/or navigation assistance data may be retrieved (e.g., according to HTTP). In one example, a URI may include an embedded LCI associated with a rough location of mobile device 105 determined based, at least in part, on contents of a message transmitted from mobile device 105.

Mobile device 105 may transmit an indoor navigation request to a location server 115 associated with a retrieved URI to request a digital map, locations of access points (e.g., for positioning) and/or other navigation assistance data. Such other navigation assistance data may include, for example associated ranging models such as physical routing constraints or heatmap information (e.g., expected signal strengths and/or signal round trip times) associated with particular locations over the area covered by the digital map. Such navigation assistance data may also include a probability heatmap for use in particle filtering techniques.

One or more maps may be transmitted from location server 115 to mobile device 105. One or more AP locations and/or ranging models may also or alternatively be transmitted from location server 115 to mobile device 105.

Mobile device 105 may transmit crowdsourced information to crowdsourcing server 120. Crowdsourcing server 120 may transmit one or more modified ranging models to location server 115. Mobile device 105 may also communicate with a PoI server 125 as shown in FIG. 1. A PoI server 125 may include information indicative of one or more points of interest, for example.

In one particular implementation, instead of having a location server directory 110 determine an LCI for an area covering a rough location of mobile device 105 (as discussed above), the local map server directory 110 may instead merely provide file location identifiers (e.g., universal resource identifiers or universal resource locators) to enable mobile device 105 to determine LCIs covering the area. Here, mobile device 105 may still provide a hint or rough location. Instead of receiving a unique LCI from the location server directory 110, however, mobile device 105 may receive file location identifiers for navigation assistance data covering areas identifiable by multiple LCIs. According to an implementation, a unique LCI covering an area including the rough location of mobile device 105 may be selected from among multiple candidate LCIs based, at least in part, on image features and/or visual cues extracted or otherwise obtained from a camera function of the mobile device. As such, a location server directory 110 need not have any capability to precisely resolve a unique LCI covering an area including a rough location of a mobile device 105. In one particular example implementation, feature recognition and/or pattern matching techniques may be applied to images captured by a camera or other imaging device. Here, an application hosted on mobile device 105 may be capable of resolving a unique LCI from among multiple LCIs. Alternatively, captured images and/or features extracted from captured images may be transmitted to a remote server to determine/select a unique LCI. In this way, disambiguation between or among a plurality or set of potential LCIs may be performed. For example, an LCI representing a floor of a building may be selected from among a group of LCIs that represent a number of floors of the building.

It should be appreciated that in some embodiments, a different approach or process may be utilized to disambiguate between LCIs. For example, in some embodiments, a mobile device may communicate with an Indoor Positioning Assistance Server Directory (IPAS-D) (or other server, for example any of the servers illustrated in FIG. 1; in some embodiments, the location server directory 110 illustrated in FIG. 1 comprises the IPAS-D) to obtain a list of nearby LCIs, a list of APs associated with those LCIs, and/or some characteristic information about the LCIs (e.g., a floor number). The mobile device may subsequently perform LCI disambiguation based, at least in part, on the information obtained from the IPAS-D, which may, for example, utilize information in the captured images. In an embodiment, e.g., and in other potential embodiments, a rough location of the mobile device may not be required. Rather, the mobile device may identify potential LCIs based on the list of APs and/or characteristic info and may use the images to disambiguate between these potential LCIs. In some embodiments, the IPAS-D may be located within or behind a LAN, such as a wireless LAN associated with a location or building; thus, in these embodiments, the mobile device may merely communicate with the IPAS-D over the WLAN without knowledge of an approximate geographic location of the mobile device. Such processes thus may not require first determining a location of the mobile device and then retrieving location data, or finding a unique landmark and then using a reverse location lookup to get a location or map for the mobile device. Instead, a disambiguation process as described herein with respect to certain embodiments may be quicker, more accurate, and/or more efficient in terms of power or processing bandwidth or data transmission, for example.

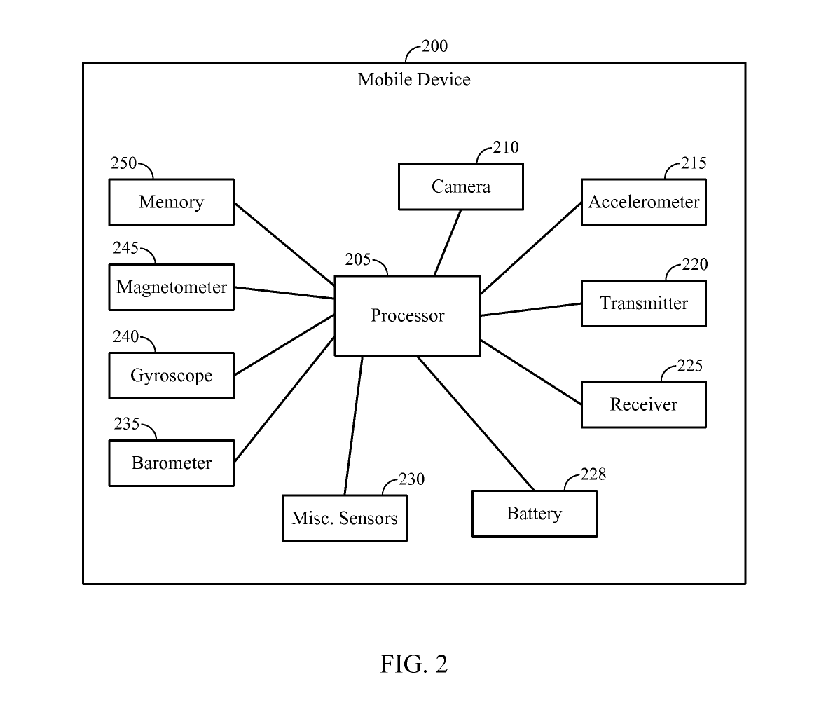

FIG. 2 is a schematic diagram of a mobile device 200 or portable electronic device according to one implementation. Mobile device 200 may include various components/circuitry, such as, for example, a processor 205, camera 210, at least one accelerometer 215, a transmitter 220, a receiver 225, a battery 228, miscellaneous sensors 230, a barometer 235, at least one gyroscope 240, a magnetometer 245, and a memory 250. By way of example but not limitation, processor 205 may include one or more processors, controllers, microprocessors, microcontrollers, application specific integrated circuits, digital signal processors, programmable logic devices, field programmable gate arrays, and the like, or any combination thereof.

Although battery 228 is shown as only being connected to processor 205, it should be appreciated that battery 228 may supply power to some, or all, of various electronic components of mobile device 200. Camera 210 may be utilized to acquire digital images for processing to identify a location of mobile device 200. One or more digital images may be stored in memory 250, for example. Memory 250 may also be utilized to store instructions or code executable by processor 205. Accelerometer 215 may detect accelerations of mobile device 200, barometer 235 may detect changes in altitude, gyroscope 240 may detect rotations, and magnetometer 245 may measure a strength or direction of a magnetic field for a compass, for example. Transmitter 220 and receiver 225 may be in communication with an antenna (not shown) of mobile device 200 for transmitting or receiving various wireless signals. Mobile device 200 may include miscellaneous sensors 230 to measure or detect additional types of movement. Such miscellaneous sensors 230 may include, for example, a magnetometer and/or a compass, to name just two among many different possible examples.

As discussed above, different LCIs may be assigned to different floors of a structure, such as a multi-story indoor area. In a particular implementation, image features or visual cues extracted from an image captured by a mobile device may be used to disambiguate between a plurality of LCIs. For example, extracted image features may be utilized to infer a specific floor or a location on the floor where the mobile device is located and therefore to determine a unique LCI identified, described, or characterized by the extracted image features, for example. In one implementation, alphanumeric character strings or numerals extracted from captured images may be used to determine a particular floor on which a mobile device is located. For example, room or office numbers may be printed, engraved, or otherwise displayed on a wall or door to identify the corresponding room or office. A repeated “2” prefix to numerals “230,” “234” or “256” may be suggestive of a location on a second floor. Accordingly, if a camera of a mobile device takes a picture of an office number, image processing techniques may be utilized to identify the office number and to determine whether the office number contains a repeated prefix. In one implementation, for example, a camera may capture or otherwise acquire images of several different office room numbers and the images may be processed to identify the various room numbers and an analysis of multiple room numbers may be performed to determine whether the room numbers contain a repeating prefix.

A repeated alphabetic prefix may similarly be indicative of location covered by a particular LCI. For example, a repeated “D**” may be suggestive of a terminal D in an airport. In an office building context, a repeated “B**” may be suggestive of a basement floor in the office building.

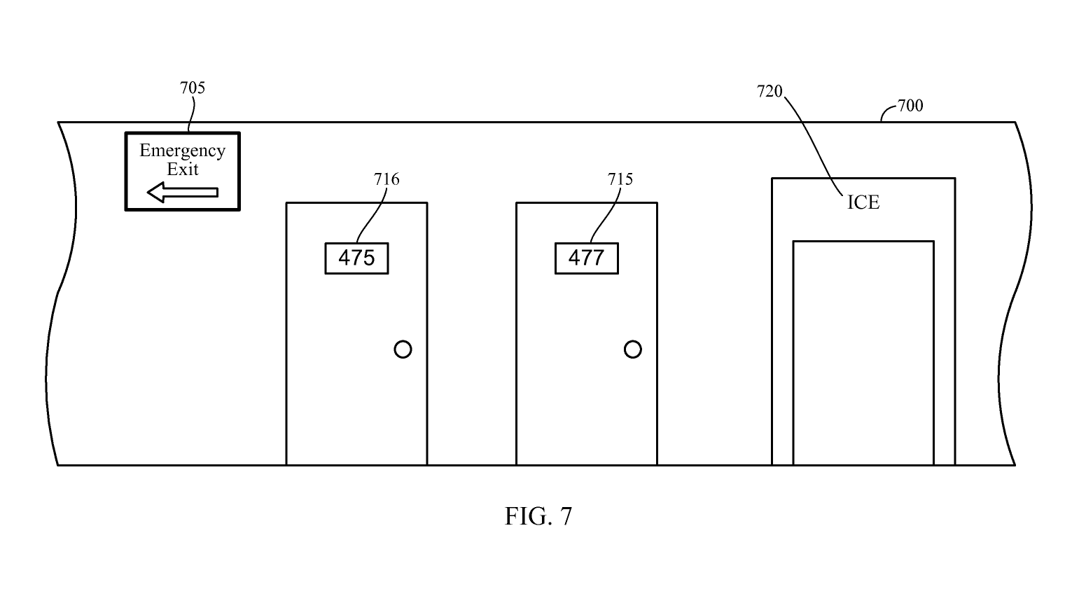

FIG. 7 illustrates an image 700 of a portion of an interior of a hotel building according to an implementation. Image 700 depicts several possible image features or visual cues, for example, for use in identifying an area within a structure. As shown, image 700 illustrates an emergency exit sign 705, a first room number 710 indicating room “475,” a second room number 715 indicating room “477,” and an ice station 720. In an example implementation, a digital camera for example disposed within or in communication with a mobile device may capture image 700. After being captured, image 700 may be processed, for example by a graphics processor within a mobile device, for example as may comprise or be implemented by processor 205 or another processor or in a server processing image 700, to identify image features or other visual cues within the image 700. In this example, image processing may identify various characters, such as letters or numbers in image 700. For example, image processing may identify emergency exit sign 705 or one or more points therein as an extracted image feature. Image processing may also identify first and second room numbers 710 and 715 by detecting numbers “475” and “477,” respectively. Similarly, the term “Ice” on a sign for ice station 720 may be identified. Various visual cues or image features identified within image 700 may collectively be utilized to characterize or identify a location of a user within a structure, in an implementation. It should be appreciated that visual cues need not include characters. For example, a window identified within an image may serve as a visual cue in some implementations if, for example, locations of windows within a structure are known to a processor processing the image. In some embodiments, the processor 205 or a portion thereof may perform such processing of the image. Similarly, locations of landmarks such as trees or buildings visible through a window pane, for example, may serve as visual cues in some implementations.

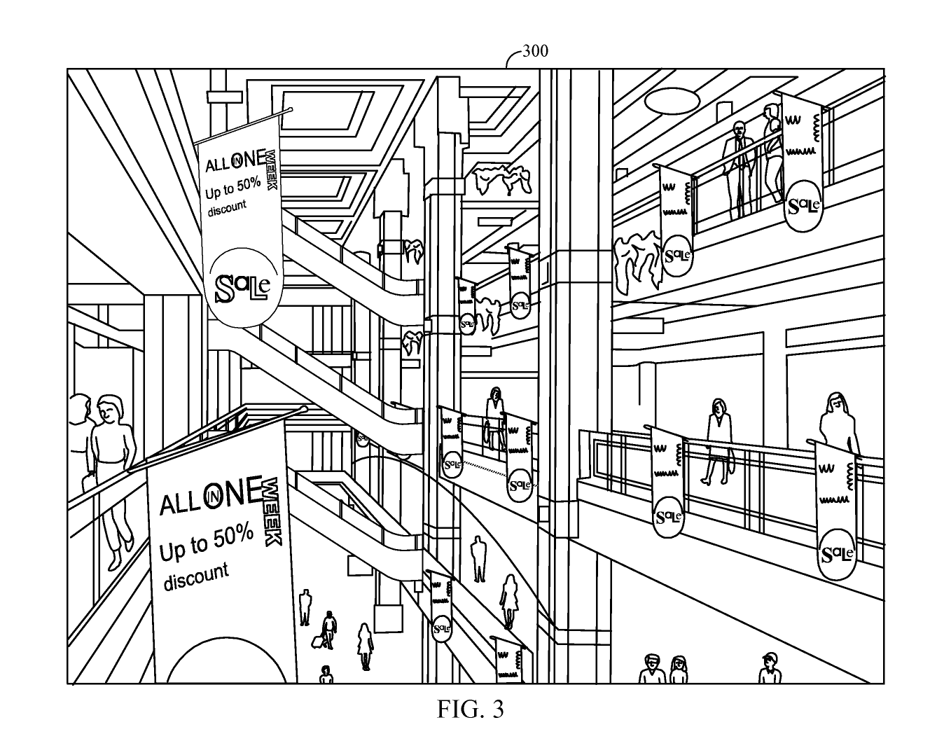

In another implementation, a multi-level view may be used for resolving a particular floor where a mobile device is located. Such a multi-level view may be available, for example, in an indoor mall area. FIG. 3 illustrates an image 300 of a multi-level view of an indoor area, such as a shopping mall, according to an implementation. As shown, image 300 shows three escalators going to floors above that on which the mobile device is currently located. For example, outputs from inertial sensors contained within a mobile device, such as an accelerometer, barometers, a gyroscope or a magnetometer, may be utilized to infer or otherwise determine whether a mobile device was tilted up, down, or pointed in a direction parallel to a floor at a time that image 300 was captured. In this example, sensors may determine that a mobile device was pointed in a direction parallel or a floor or the ground to capture an image located at the same height as the mobile device at a time that image 300 was captured and it may therefore be inferred that three escalators shown in image 300 lead to higher floors. Further, elements intrinsic to an image may be used to determine a pose of an image which may be determined based at least in part on a tilt of the mobile device at a time at which the image was captured. In one example, an angle of certain features such as, for example, a skew of a store sign, may be used to determine an image pose. Accordingly, if an LCI listing for a structure in which a mobile device is located is known to contain five floors, detection of three escalators leading to higher floors may be utilized to infer or otherwise determine that a user carrying the mobile device is therefore located no higher than the second floor. In other words, an LCI detection of three escalators may be utilized to infer a subset of floors upon which a user may be located.

Additional information shown in image 300 may also be utilized to infer or otherwise determine a floor on which a user was located at a time image 300 was taken. A roof or floor, for example, may indicate minimum and maximum floors that may be matched against features of LCIs in a list. As another example, doors or windows located on top of one another may indicate that there are multiple different levels shown in image 300. Floors may be identified, for example, by locating certain straight, parallel lines in image 300. An angle of floors shown in image 300 may be utilized in combination with a determined orientation of a mobile device having a camera from which image 300 was captured to determine that a user was located on the second floor at a time that the image 300 was captured. If a camera is held at an angle, for example, a number of possible different floor or level choices may be reduced even if processing techniques are unable to determine exactly whether a user was located on a first or second floor at a time that image 300 was captured. An angle of a camera or a likelihood that the camera may be tilted may be determined based on, or with respect to, a gravity vector calculated at the mobile device 200 using measurements from one or more of the sensors described above with respect to FIG. 2 in some embodiments.

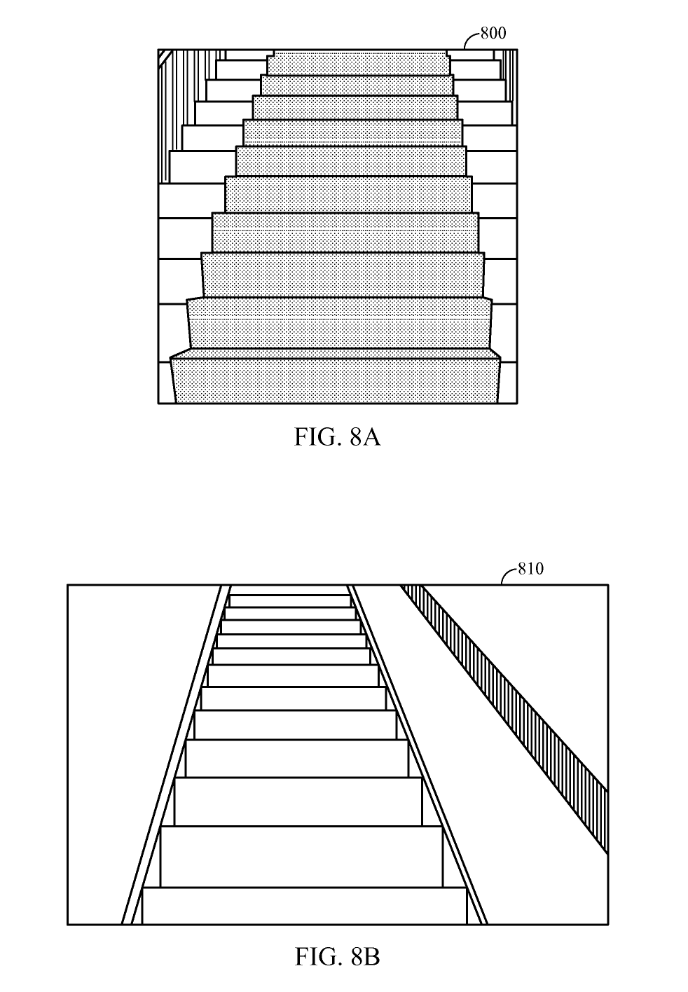

In another implementation, images captured at a mobile device may, in combination with an observed orientation of the mobile device according to inertial sensor measurements, be used to determine whether a user carrying a mobile device is ascending or descending a staircase or escalator between floors of a building. FIG. 8A is an image 800 of a staircase being descended according to an implementation. FIG. 8B is an image 810 of a staircase being ascended according to an implementation. As shown, images 800 and 810 appear to be similar; accordingly, an image processor may experience difficultly in determining whether a user is ascending or descending a staircase shown in either of these images. Therefore, additional sensor measurements may be utilized to determine whether a user is ascending or descending a staircase. For example, if image features indicating that a user may be ascending a staircase are detected, a gyroscope or accelerometer or other sensor may be utilized to infer that the user is moving onto a floor located above (or below) a floor which may be associated with features extracted from previously captured images.

In an example implementation, sensor measurements may be stored as image meta data in a memory or may be associated with one or more video frames captured while panning a camera of a mobile device. For example, gyroscope data or measurements may be utilized to determine an angle of a camera of a mobile device at a time at which an image was captured, to differentiate between ascending or descending stairs. For example, a user walking down stairs may lean forward while capturing an image, whereas a user walking up stairs may lean backward while capturing an image.

In some implementations, a plurality of LCIs may be stored on the mobile device, for example because they were previously retrieved or because the device is a priori associated with the plurality of LCIs. In one example, a mobile device used for self-guided tours of a museum may be programmed with LCIs associated with the museum. Thus, the mobile device is not required to contact a server to retrieve the LCIs. In such example, a particular LCI may be identified based on a visual cue that is uniquely associated with the particular LCI. For example, a certain painting or exhibit may be used to select an LCI corresponding to a wing or floor of the museum on which the mobile device is located.

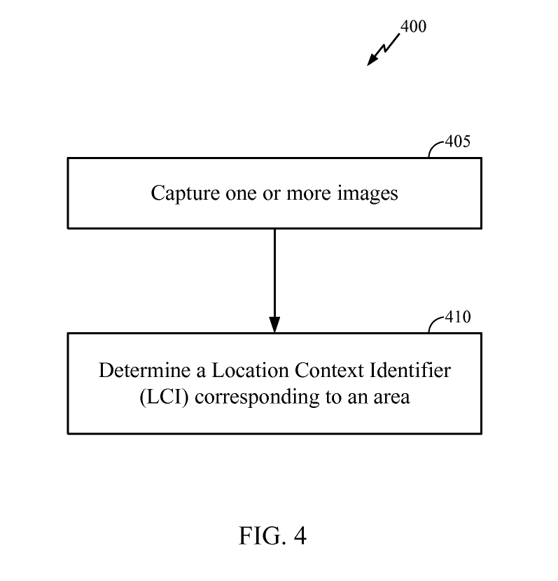

FIG. 4 is a flowchart 400 of a process for determining an LCI for an area according to an implementation. At operation 405, one or more images may be captured. For example, as discussed above, one or more images may be captured via a camera of a mobile device. For example, a camera 210 as shown in FIG. 2 may capture such images. At operation 410, a location context identifier (LCI) corresponding to an area including a location of the mobile device is determined based, at least in part, on one or more captured images, where the LCI is selected from among a plurality of LCIs. For example, an LCI may be selected from a plurality of LCIs by a processor 205 of a mobile device 200 as shown in FIG. 2. Alternatively, a selection on an LCI may be performed by a network via image or sensor information provided or transmitted by a mobile device having a camera.

In one implementation, a user may initiate a mapping application via a mobile device. For example, a mapping application may provide instructions, such as visually or audibly, to direct a user to capture images that may be utilized to identify a location within a structure, such as a building. For example, a mapping application may instruct a user to capture images of room numbers, store signage, or other landmark information such as known statues or locations of benches or chairs. As another example, a display of the mobile device may indicate a direction in which the user should pan. For example, a display of the a mobile device may present instructions such as “pan camera clockwise,” “pan camera counterclockwise,” “tilt camera upward to a 45 degree angle,” or “tilt camera downward to a 60 degree angle,” or may simply display an arrow or other visual cue to move the camera in a particular direction or motion, to name just a few among many possible different example instructions.

Output from inertial sensors at a time at which an image is captured by a mobile device may be utilized to disambiguate between LCIs. For example, a captured image may be paired with inertial sensor data associated with a time at which the captured image was captured so that an orientation or other movement of a camera of a mobile device is determined at a time at which the captured image was captured. Accordingly, such sensor data may be used to infer that a camera was tilted up, down, or pointed forward at a height parallel to the ground at a time that an image was captured. Sensor data may be associated with an image or while video frames captured while panning a camera of a mobile device via use of image meta tags, for example.

Various images and associated sensor data may be utilized to determine an LCI associated with a location at which a mobile device was located at a particular time that images were captured. A process of elimination may, for example, be utilized to reduce a number of possible LCIs to narrow down possible LCIs associated with a location at which an image was captured. For example, if an image was captured while a user held a mobile device in a atrium of a thirty-story building, and if ten escalators travelling upward are visible and are located above each other, processing may be utilized to determine that there are ten floors or stories located above a current floor on which the mobile device was held while capturing the image. Accordingly, processing may determine that of thirty possible floors, a user is therefore located somewhere between floors one and twenty. Additional information may be utilized to narrow down possible LCIs associated with a location of a user of a mobile device, such as room numbers, or store signage, for example. If a mapping application has insufficient information to determine a location, instructions may be presented to direct a user to capture certain images, as discussed above, for example. As additional data points or information are acquired from successive images or sensors, a number of potential LCIs may be eliminated until one particular LCI is determined to cover a current location of a user or a potential LCI is determined to have a likelihood above a threshold probability. For example, such a process may be performed successively or iteratively until an LCI covering a current location of a user of a mobile device is determined with a relatively high degree of precision or confidence, or that is associated with a relatively lower error estimate. For example, a process may be continued to acquire additional information from images until an error estimate associated with a determined LCI is associated with an acceptably low error estimate, such as a maximum threshold error estimate. In one example, a minimum mean squared error (MMSE) process may be implemented to acquire additional data points or information in images until an error measurement is determined to fall below a maximum error threshold value. In one implementation, if a plurality of potential LCIs remain after the LCI elimination, a maximum likelihood estimate detector or classifier may be used to select from among the remaining LCIs. In one implementation, if a particular LCI cannot be determined or cannot be selected with a certain confidence, the mobile device may return an error, may wait for additional data, or may direct the user to capture additional information, for example.

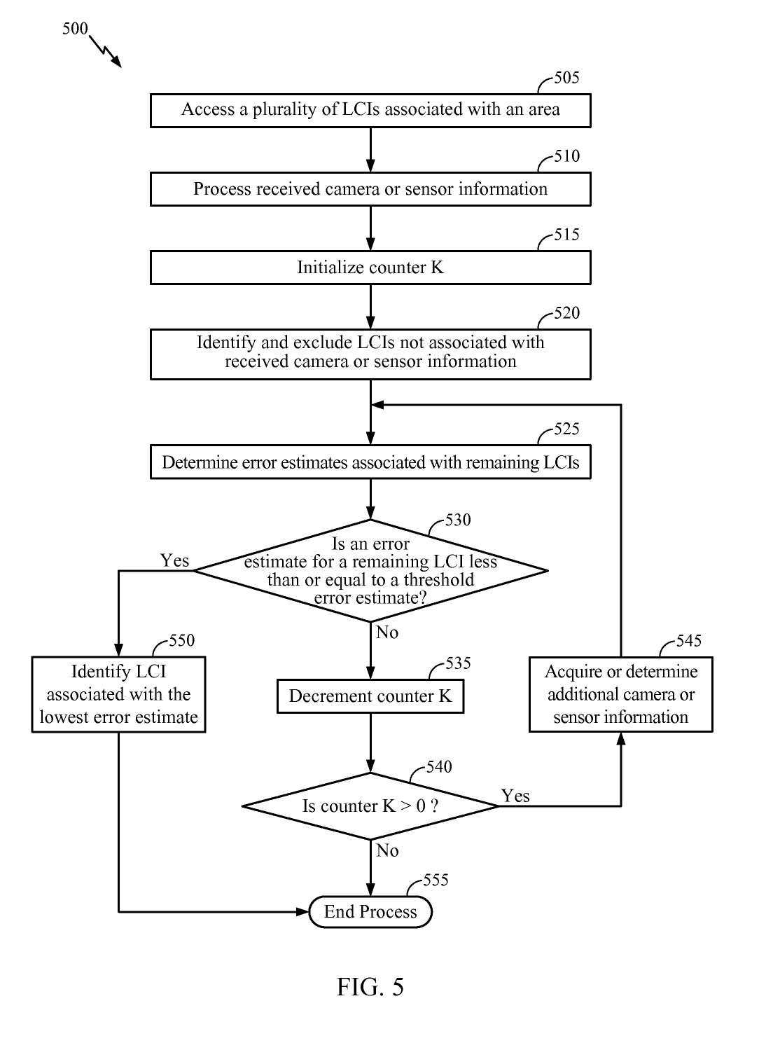

FIG. 5 is a flowchart of a process for disambiguating between or among a plurality of LCIs according to an implementation. At operation 505 a plurality of LCIs covering an area may be accessed or acquired. For example, LCIs stored in a database or in a local memory may be accessed or acquired. At operation 510, received camera or sensor information, such as one or more images and/or mobile station or camera sensor measurements, may be processed. At operation 515, a counter K may be initialized 515. Counter K may be utilized, for example, to ensure that a process shown in FIG. 5 is performed for a limited amount of time or for no more than a certain number of iterations. It should be appreciated in some implementations, a timer may be used instead of counter K.

At operation 520, LCIs not covering received camera or sensor information may be identified and excluded. For example, as discussed above, if it is determined from a captured image that there are four floors above a floor on which a user is currently located, LCIs for those four floors may be excluded from consideration. At operation 525, error estimates associated with remaining LCIs may be determined. In some implementations, a measurement of confidence may be used instead of or in addition to an error estimate. At operation 530, a determination may be made as to whether any error estimates for remaining LCIs are less than or equal to a threshold error estimate. For example, if a particular LCI is associated with an error estimate less than or equal to a maximum error threshold, there is a strong likelihood that the particular LCI corresponds to the received camera or sensor information. If “yes,” at operation 530, processing proceeds to operation 550; otherwise, if “no,” processing proceeds to operation 535.

Counter K may be decremented at operation 535. At operation 540, a determination may be made as to whether counter K is greater than a value of “0.” If “yes,” processing proceeds to operation 545; if “no,” processing proceeds to operation 555.

At operation 550, an LCI associated with the lowest error estimate may be identified. For example, mapping information associated with the LCI may be transmitted to or otherwise acquired by a mobile device. At operation 555, processing ends. For example, processing may either end because an LCI covering an area determined based at least in part on received image features or inertial sensor information has been identified at operation 550. Alternatively, processing may end because an appropriate LCI was not identified within a number of iterations specified by counter K or within a certain allowed time period.

In some embodiments, a plurality of images may be captured. In one aspect, a plurality of still pictures may be captured. In another aspect, a plurality of images may be obtained from a video such as if a user pans with the mobile device. A plurality of LCIs may initially be identified for a location corresponding to a plurality of images. The most likely LCI for a location corresponding to a plurality of images may subsequently be determined from the plurality of LCIs. In one embodiment, a confidence of an LCI selection may be determined based on the number of images that are associated with the most likely LCI. In some aspects, a single LCI is determined based on a combination of the plurality of images. The LCI determined for each image or frame may be appended to the image or frame, for example, as metadata. The determined LCI(s) may be used to train the mobile device, for learning to increase accuracy of future LCI determinations, or may be stored in a cache of the mobile device or a server along with a corresponding image so that the LCI may be quickly retrieved for similar images.

A method for LCI disambiguation, as discussed herein, may provide numerous advantages. For example, if a rough location of a mobile device may initially be determined, such as by determining or otherwise obtaining information, such as a beacon, indicating that the mobile device is within an area such as an enclosed structure, such as a shopping mall or office building, a camera may capture or otherwise obtain images of the surrounding environment. For example, information such as features, landmarks, or orientations identified within one or more obtained or captured images may be utilized to disambiguate between various LCIs corresponding to different areas, sections, or places within the structure. Accordingly, a time to identify the correct LCI in which the mobile device is located and/or a time to first fix (TTFF) may therefore be reduced or location estimation performance may otherwise be improved, for example in a “cold start” scenario, such as if a mobile device is powered up and initially does not know its location. Moreover, a more accurate first (and subsequent) LCI determination or identification may also be realized based at least in part on analysis of one or more obtained or captured images. Of course, such advantages or benefits may therefore result in more accurate positioning or navigation, for example, and may reduce network traffic, e.g., by reducing the transmission of various multiple LCIs to a mobile device that are unrelated to the mobile device's current location or position.

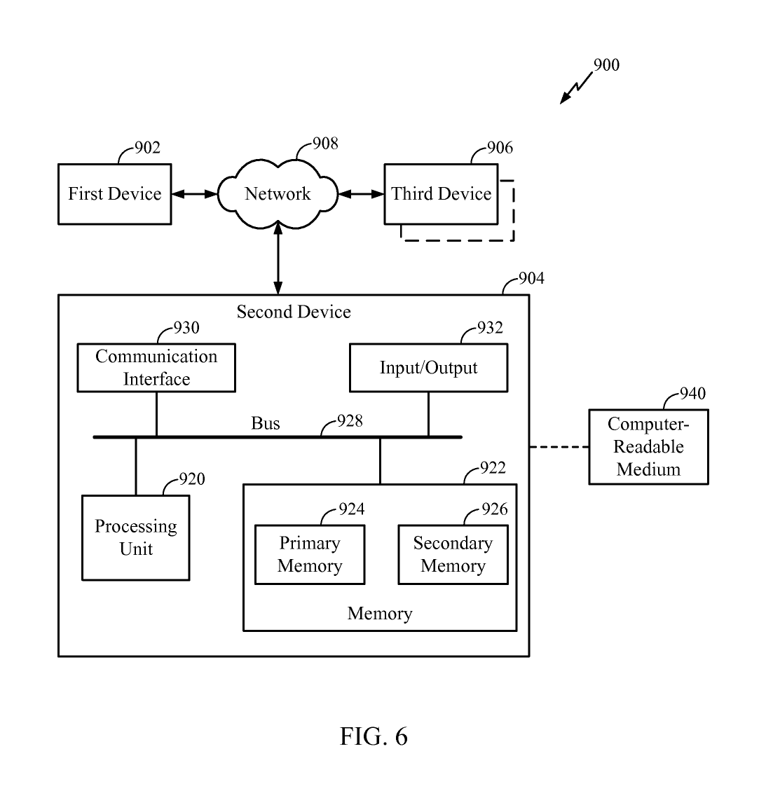

A process as shown in FIG. 5 may be performed entirely or partially by a mobile device. For example, with respect to mobile device 200 shown in FIG. 2, camera 210 may capture images and/or sensor information or measurements may be acquired from accelerometer 215, barometer 235, and/or gyroscope 240. Mobile device 200 may disambiguate between LCIs based at least in part on captured images and/or sensor information, or a network device may perform the disambiguation. In some embodiments, one or more of the operations 505-555 illustrated in FIG. 5 may be performed by processor 205 of a mobile device 200 as shown in FIG. 2. In some embodiments, one or more of the operations 505-555 illustrated in FIG. 5 may be performed by a server or other network device. For example, one or more of the operations 505-555 may be performed by a processing unit, such as the processing unit 920 illustrated in FIG. 6.

FIG. 6 is a schematic diagram illustrating an example system 900 that may include one or more devices configurable to implement techniques or processes described above, for example, in connection with example techniques for disambiguating between or among LCIs according to an implementation. System 900 may include, for example, a first device 902, a second device 904, and a third device 906, which may be operatively coupled together through a communications network 908.

First device 902, second device 904 and third device 906, as shown in FIG. 5, may be representative of any device, appliance or machine that may be configurable to exchange data over communications network 908. By way of example but not limitation, any of first device 902, second device 904, or third device 906 may include: one or more computing devices or platforms, such as, e.g., a desktop computer, a laptop computer, a workstation, a server device, or the like; one or more personal computing or communication devices or appliances, such as, e.g., a personal digital assistant, mobile communication device, or the like; a computing system or associated service provider capability, such as, e.g., a database or data storage service provider/system, a network service provider/system, an Internet or intranet service provider/system, a portal or search engine service provider/system, a wireless communication service provider/system; or any combination thereof. Any of the first, second, and third devices 902, 904, and 906, respectively, may comprise one or more of a mobile device, fixed location receiver, wireless access point, mobile receiver in accordance with the examples described herein. Similarly, any of first, second, and third devices 902, 904, and 906, respectively, may comprise one or more of mobile device 105, location server directory 110, location server 115, crowdsourcing server 120, or PoI server 125, for example.

Similarly, network 908 may be representative of one or more communication links, processes, or resources configurable to support the exchange of data between at least two of first device 902, second device 904, and third device 906. By way of example but not limitation, network 908 may include wireless or wired communication links, telephone or telecommunications systems, data buses or channels, optical fibers, terrestrial or space vehicle resources, local area networks, wide area networks, intranets, the Internet, routers or switches, and the like, or any combination thereof. As illustrated, for example, by the dashed lined box illustrated as being partially obscured of third device 906, there may be additional like devices operatively coupled to network 908.

It is recognized that all or part of the various devices and networks shown in system 900, and the processes and methods as further described herein, may be implemented using or otherwise including hardware, firmware, software, or any combination thereof.

Thus, by way of example but not limitation, second device 904 may include at least one processing unit 920 that is operatively coupled to a memory 922 through a bus 928.

Processing unit 920 is representative of one or more circuits configurable to perform at least a portion of a data computing procedure or process. By way of example but not limitation, processing unit 920 may include one or more processors, controllers, microprocessors, microcontrollers, application specific integrated circuits, digital signal processors, programmable logic devices, field programmable gate arrays, and the like, or any combination thereof.

Memory 922 is representative of any data storage mechanism. Memory 922 may include, for example, a primary memory 924 or a secondary memory 926. Primary memory 924 may include, for example, a random access memory, read only memory, etc. While illustrated in this example as being separate from processing unit 920, it should be understood that all or part of primary memory 924 may be provided within or otherwise co-located/coupled with processing unit 920.

Secondary memory 926 may include, for example, the same or similar type of memory as primary memory or one or more data storage devices or systems, such as, for example, a disk drive, an optical disc drive, a tape drive, a solid state memory drive, etc. In certain implementations, secondary memory 926 may be operatively receptive of, or otherwise configurable to couple to, a computer-readable medium 940. Computer-readable medium 940 may include, for example, any non-transitory medium that can carry or make accessible data, code or instructions for one or more of the devices in system 900. Computer-readable medium 940 may also be referred to as a storage medium.

Second device 904 may include, for example, a communication interface 930 that provides for or otherwise supports the operative coupling of second device 904 to at least network 908. By way of example but not limitation, communication interface 930 may include a network interface device or card, a modem, a router, a switch, a transceiver, and the like.

Second device 904 may include, for example, an input/output device 932. Input/output device 932 is representative of one or more devices or features that may be configurable to accept or otherwise introduce human or machine inputs, or one or more devices or features that may be configurable to deliver or otherwise provide for human or machine outputs. By way of example but not limitation, input/output device 932 may include an operatively configured display, speaker, keyboard, mouse, trackball, touch screen, data port, etc.

In an implementation, second device 904 shown in FIG. 6 may comprise mobile device 200 shown in FIG. 2. Similarly, memory 922 shown in FIG. 6 may comprise memory 250 shown in FIG. 2. Processing unit 920 shown in FIG. 6 may comprise processor 205 shown in FIG. 2. Communication interface 930 shown in FIG. 6 may comprise transmitter 220 and/or receiver 225 shown in FIG. 2. In another implementation, second device 904 may comprise a server or other network device that receives data or information from mobile device 200.

By way of example, any of first, second, and third devices 902, 904, and 906, respectively, may comprise, for example, means for performing one or more functions. For example, any of first, second, and third devices 902, 904, and 906 (or elements thereof, for example one or more of the elements 920-932 or other elements), respectively, may comprise, for example, means for performing various functions, such as obtaining one or more images captured at a mobile device, determining a location context identifier (LCI) identifying, describing, or characterizing an area including a location of the mobile device based, at least in part, on the one or more obtained images, transmitting information associated with the one or more obtained images to a server, or receiving the LCI corresponding to the area from the server. Similarly, for example, any of first, second, and third devices 902, 904, and 906 (or elements thereof, for example one or more of the elements 920-932 or other elements), respectively, may comprise, for example, means for selecting, at the mobile device, an LCI corresponding to an area from among the plurality of LCIs, means for identifying a repeating prefix in alphanumeric character strings in one or more obtained images, means for associating the repeating prefix with the LCI corresponding to the area, means for recognizing one or more features of a multi-level view in the one or more obtained images, or means for inferring a location of the mobile device as being on a subset of floors of a building based, at least in part, on one or more features. Any of first, second, and third devices 902, 904, and 906 (or elements thereof, for example one or more of the elements 920-932 or other elements), respectively, may additionally or alternatively comprise, for example, means for inferring a location of a mobile device as being on a subset of floors, means for inferring the location based, at least in part, on an orientation of the mobile device, means for distinguishing between floors of a building based, at least in part, on a detected direction of movement of the mobile device with respect to a staircase, means for determining whether the mobile device is ascending or descending the staircase, or means for determining an LCI based on at least one image feature in one or more obtained images.

Methodologies described herein may be implemented by various means depending upon applications according to particular features or examples. For example, such methodologies may be implemented in hardware, firmware, software, discrete/fixed logic circuitry, any combination thereof, and so forth. In a hardware or logic circuitry implementation, for example, a processing unit may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other devices or units designed to perform the functions described herein, or combinations thereof, just to name a few examples.

For a firmware or software implementation, the methodologies may be implemented with modules (e.g., procedures, functions, etc.) having instructions that perform the functions described herein. Any machine readable medium tangibly embodying instructions may be used in implementing the methodologies described herein. For example, software codes may be stored in a memory and executed by a processor. Memory may be implemented within the processor or external to the processor. As used herein the term “memory” refers to any type of long term, short term, volatile, nonvolatile, or other memory and is not to be limited to any particular type of memory or number of memories, or type of media upon which memory is stored. In at least some implementations, one or more portions of the herein described storage media may store signals representative of data or information as expressed by a particular state of the storage media. For example, an electronic signal representative of data or information may be “stored” in a portion of the storage media (e.g., memory) by affecting or changing the state of such portions of the storage media to represent data or information as binary information (e.g., ones and zeros). As such, in a particular implementation, such a change of state of the portion of the storage media to store a signal representative of data or information constitutes a transformation of storage media to a different state or thing.

As was indicated, in one or more example implementations, the functions described may be implemented in hardware, software, firmware, discrete/fixed logic circuitry, some combination thereof, and so forth. If implemented in software, the functions may be stored on a physical computer-readable medium as one or more instructions or code. Computer-readable media include physical computer storage media. A storage medium may be any available physical medium that can be accessed by a computer. By way of example, and not limitation, such computer-readable media can comprise RAM, ROM, EEPROM, CD-ROM or other optical disc storage, magnetic disk storage or other magnetic storage devices, or any other medium that can be used to store desired program code in the form of instructions or data structures and that can be accessed by a computer or processor thereof. Disk and disc, as used herein, includes compact disc (CD), laser disc, optical disc, digital versatile disc (DVD), floppy disk and blue-ray disc where disks usually reproduce data magnetically, while discs reproduce data optically with lasers.

As discussed above, a mobile device may be capable of communicating with one or more other devices via wireless transmission or receipt of information over various communications networks using one or more wireless communication techniques. Here, for example, wireless communication techniques may be implemented using a wireless wide area network (WWAN), a wireless local area network (WLAN), a wireless personal area network (WPAN), or the like. The term “network” and “system” may be used interchangeably herein. A WWAN may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, a Long Term Evolution (LTE) network, a WiMAX (IEEE 802.16) network, and so on. A CDMA network may implement one or more radio access technologies (RATs) such as cdma2000, Wideband-CDMA (W-CDMA), Time Division Synchronous Code Division Multiple Access (TD-SCDMA), to name just a few radio technologies. Here, cdma2000 may include technologies implemented according to IS-95, IS-2000, and IS-856 standards. A TDMA network may implement Global System for Mobile Communications (GSM), Digital Advanced Mobile Phone System (D-AMPS), or some other RAT. GSM and W-CDMA are described in documents from a consortium named “3rdGeneration Partnership Project” (3GPP). Cdma2000 is described in documents from a consortium named “3rd Generation Partnership Project 2” (3GPP2). 3GPP and 3GPP2 documents are publicly available. A WLAN may include an IEEE 802.11x network, and a WPAN may include a Bluetooth network, an IEEE 802.15x, or some other type of network, for example. The techniques may also be implemented in conjunction with any combination of WWAN, WLAN, or WPAN. Wireless communication networks may include so-called next generation technologies (e.g., “4G”), such as, for example, Long Term Evolution (LTE), Advanced LTE, WiMAX, Ultra Mobile Broadband (UMB), or the like.

In one particular implementation, a mobile device may, for example, be capable of communicating with one or more femtocells facilitating or supporting communications with the mobile device for the purpose of estimating its location, orientation, velocity, acceleration, or the like. As used herein, “femtocell” may refer to one or more smaller-size cellular base stations that may be enabled to connect to a service provider's network, for example, via broadband, such as, for example, a Digital Subscriber Line (DSL) or cable. Typically, although not necessarily, a femtocell may utilize or otherwise be compatible with various types of communication technology such as, for example, Universal Mobile Telecommunications System (UTMS), Long Term Evolution (LTE), Evolution-Data Optimized or Evolution-Data only (EV-DO), GSM, Worldwide Interoperability for Microwave Access (WiMAX), Code division multiple access (CDMA)-2000, or Time Division Synchronous Code Division Multiple Access (TD-SCDMA), to name just a few examples among many possible. In certain implementations, a femtocell may comprise integrated WiFi, for example. However, such details relating to femtocells are merely examples, and claimed subject matter is not so limited.

Also, computer- or machine-readable code or instructions may be transmitted via signals over physical transmission media from a transmitter to a receiver (e.g., via electrical digital signals). For example, software may be transmitted from a website, server, or other remote source using a coaxial cable, fiber optic cable, twisted pair, digital subscriber line (DSL), or physical components of wireless technologies such as infrared, radio, and microwave. Combinations of the above may also be included within the scope of physical transmission media. Such computer instructions or data may be transmitted in portions (e.g., first and second portions) at different times (e.g., at first and second times). Some portions of this Detailed Description are presented in terms of algorithms or symbolic representations of operations on binary digital signals stored within a memory of a specific apparatus or special purpose computing device, apparatus, or platform. In the context of this particular Specification, the term specific apparatus or the like includes a general purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and generally, considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared, or otherwise manipulated.

It has proven convenient at times, principally for reasons of common usage, to refer to such signals as bits, information, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this Specification discussions utilizing terms such as “processing,” “computing,” “calculating,” “determining,” “ascertaining,” “identifying,” “associating,” “measuring,” “performing,” or the like refer to actions or processes of a specific apparatus, such as a special purpose computer or a similar special purpose electronic computing apparatus or device. In the context of this Specification, therefore, a special purpose computer or a similar special purpose electronic computing device or apparatus is capable of manipulating or transforming signals, typically represented as physical electronic, electrical, or magnetic quantities within memories, registers, or other information storage devices, transmission devices, or display devices of the special purpose computer or similar special purpose electronic computing device or apparatus.

Terms, “and” and “or” as used herein, may include a variety of meanings that also is expected to depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures or characteristics. Though, it should be noted that this is merely an illustrative example and claimed subject matter is not limited to this example.

While certain example techniques have been described and shown herein using various methods or systems, it should be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to particular examples disclosed, but that such claimed subject matter may also include all implementations falling within the scope of the appended claims, and equivalents thereof.

1. A method comprising:
obtaining one or more images captured at a mobile device; and
determining a location context identifier (LCI) identifying an area including a location of the mobile device based, at least in part, on the one or more obtained images, the LCI being selected from among a plurality of LCIs.

2. The method of claim 1, wherein the determining comprises transmitting information associated with the one or more obtained images to a server from the mobile device, and receiving the LCI corresponding to the area from the server.

3. The method of claim 1, wherein the determining comprises selecting, at the mobile device, the LCI corresponding to the area from among the plurality of LCIs.

4. The method of claim 3, wherein selecting the LCI corresponding to the area further comprises:
identifying a repeating prefix in alphanumeric character strings in the one or more obtained images; and
associating the repeating prefix with the LCI corresponding to the area.

5. The method of claim 3, wherein selecting the LCI corresponding to the area further comprises:
recognizing one or more features of a multi-level view in the one or more obtained images; and
inferring the location of the mobile device as being on a subset of floors of a building based, at least in part, on the one or more features.

6. The method of claim 5, wherein the inferring the location of the mobile device as being on a subset of floors is further based, at least in part, on an orientation of the mobile device.

7. The method of claim 5, wherein the one or more features comprise an escalator or staircase.

8. The method of claim 5, wherein the one or more features comprise a plurality of similar elements that are vertically displaced relative to each other.

9. The method of claim 8, wherein the plurality of similar elements comprise doors, floors, or signs.

10. The method of claim 1, further comprising distinguishing between floors of a building based, at least in part, on a detected direction of movement of the mobile device with respect to a staircase.

11. The method of claim 10, wherein distinguishing between floors of the building further comprises determining whether the mobile device is ascending or descending the staircase based, at least in part, on an orientation of the mobile device and the one or more obtained images.

12. The method of claim 1, wherein the LCI covering the area is selected based on at least one image feature extracted from the one or more obtained images, the at least one image feature being uniquely associated with the LCI covering the area.

13. The method of claim 12, wherein the at least one image feature comprises a printed name of a business.

14. An apparatus comprising:
means for obtaining one or more images captured at a mobile device; and
means for determining a location context identifier (LCI) identifying an area including a location of the mobile device based, at least in part, on the one or more obtained images, the LCI being selected from among a plurality of LCIs.

15. The apparatus of claim 14, further comprising means for transmitting information associated with the one or more obtained images to a server, and means for receiving the LCI corresponding to the area from the server.

16. The apparatus of claim 14, wherein the means for determining comprises means for selecting, at the mobile device, the LCI corresponding to the area from among the plurality of LCIs.

17. The apparatus of claim 16, wherein the means for selecting the LCI corresponding to the area further comprises:
means for identifying a repeating prefix in alphanumeric character strings in the one or more obtained images; and
means for associating the repeating prefix with the LCI corresponding to the area.

18. The apparatus of claim 16, wherein selecting the LCI corresponding to the area further comprises:
means for recognizing one or more features of a multi-level view in the one or more obtained images; and
means for inferring the location of the mobile device as being on a subset of floors of a building based, at least in part, on the one or more features.

19. The apparatus of claim 18, wherein the means for inferring the location of the mobile device as being on a subset of floors comprises means for inferring the location further based, at least in part, on an orientation of the mobile device.

20. The apparatus of claim 18, wherein the one or more features comprise an escalator or staircase.

21. The apparatus of claim 18, wherein the one or more features comprise a plurality of similar elements that are vertically displaced relative to each other.

22. The apparatus of claim 21, wherein the plurality of similar elements comprise doors, floors, or signs.

23. The apparatus of claim 14, further comprising means for distinguishing between floors of a building based, at least in part, on a detected direction of movement of the mobile device with respect to a staircase.

24. The apparatus of claim 23, wherein the means for distinguishing between floors of the building further comprises means for determining whether the mobile device is ascending or descending the staircase based, at least in part, on an orientation of the mobile device and the one or more obtained images.

25. The apparatus of claim 14, wherein the means for determining the LCI covering the area comprises means for determining the LCI based on at least one image feature in the one or more obtained images, the at least one image feature being uniquely associated with the LCI covering the area.

26. The apparatus of claim 25, wherein the at least one image feature comprises a printed name of a business.

27. An apparatus comprising:
a memory; and
a processor in communication with the memory, the processor being configured to:
process one or more images captured at a mobile device; and
determine a location context identifier (LCI) identifying an area including a location of the mobile device based, at least in part, on the one or more captured images, the LCI being selected from among a plurality of LCIs.

28. The apparatus of claim 27, further comprising a transmitter to transmit information associated with the one or more captured images to a server.

29. The apparatus of claim 28, further comprising a receiver to receive the LCI corresponding to the area from the server.

30. The apparatus of claim 27, wherein the processor is configured to select the LCI corresponding to the area from among the plurality of LCIs.

31. The apparatus of claim 30, wherein the processor is further configured to:
identify a repeating prefix in alphanumeric character strings in the one or more captured images; and
associate the repeating prefix with the LCI corresponding to the area.

32. The apparatus of claim 30, wherein the processor is further configured to:
recognize one or more features of a multi-level view in the one or more captured images; and
infer the location of the mobile device as being on a subset of floors of a building based, at least in part, on the one or more features.

33. The apparatus of claim 32, wherein the processor is further configured to infer the location further based, at least in part, on an orientation of the mobile device.

34. The apparatus of claim 32, wherein the one or more features comprise an escalator or staircase.

35. The apparatus of claim 32, wherein the one or more features comprise a plurality of similar elements that are vertically displaced relative to each other.

36. The apparatus of claim 35, wherein the plurality of similar elements comprise doors, floors, or signs.

37. The apparatus of claim 27, wherein the processor is further configured to distinguish between floors of a building based, at least in part, on a detected direction of movement of the mobile device with respect to a staircase.

38. The apparatus of claim 37, wherein the processor is further configured to determine whether the mobile device is ascending or descending the staircase based, at least in part, on an orientation of the mobile device and the one or more captured images.

39. The apparatus of claim 27, wherein the processor is further configured to determine the LCI based on at least one image feature in the one or more captured images, the at least one image feature being uniquely associated with the LCI corresponding to the area.

40. The apparatus of claim 39, wherein the at least one image feature comprises a printed name of a business.

41. A non-transitory storage medium having machine-readable instructions stored thereon which are executable by a special purpose computing apparatus to:
obtain one or more images captured at a mobile device; and
determine a location context identifier (LCI) identifying an area including a location of the mobile device based, at least in part, on the one or more obtained images, the LCI being selected from among a plurality of LCIs.

42. The non-transitory storage medium of claim 41, wherein the machine-readable instructions are further executable by the special purpose computing apparatus to select the LCI corresponding to the area from among the plurality of LCIs.
